(19) United States
(12) Patent Application Publication
(10) Pub. No.: US 2007/0047225 A1
(43) Pub. Date: Mar. 1, 2007

(54) Direct type backlight device for liquid crystal module

(75) Inventor: Tatsuji Sudo, Daito-shi (JP)

Correspondence Address: GLOBAL IP COUNSELORS, LLP, 1233 20TH STREET, NW, SUITE 700, WASHINGTON, DC, 20036-2680, US

(73) Assignee: FUNAI ELECTRIC CO., LTD., Daito-shi (JP)

(21) Appl. No.: 11/497,287

(22) Filed: Aug. 2, 2006

(30) Foreign Application Priority Data
Aug. 30, 2005 (JP) JP 2005-248889

(51) Int. Cl. F21V 7/00

(52) U.S. Cl. 362/225; 362/240; 362/241; 362/247

(57) ABSTRACT

A direct type backlight device for a liquid crystal module having a liquid crystal panel includes a resin molded frame, a reflective sheet, a light diffuser plate and at least one crosspiece. The resin molded frame attaches linear light sources in parallel at a plurality of sites spaced apart. The reflective sheet is disposed on one side of the frame. The light diffuser plate is disposed on another side of the frame. The crosspiece is fixed to the frame between adjacent linear light sources and has a light reflecting surface. Light transmitted through the light diffuser plate illuminates the liquid crystal panel.

### CROSS-REFERENCE TO RELATED APPLICATIONS

This application claims priority to Japanese Patent Application No. 2005-248889. The entire disclosure of Japanese Patent Application No. 2005-248889 is hereby incorporated herein by reference.

### BACKGROUND OF THE INVENTION

1. Field of the Invention

The present invention generally relates to a direct type backlight device for a liquid crystal module. More specifically, the present invention relates to a direct type backlight device for a liquid crystal module having a liquid crystal panel.

2. Background Information

A liquid crystal module has a reflective sheet, a light diffuser plate and a frame (a resin molding). The reflective sheet and the light diffuser plate sandwich the frame. A plurality of linear light sources (fluorescent tubes) are attached to the frame. The light emitted from the linear light sources is reflected by the reflective sheet. The light is also diffused by the light diffuser plate so that the liquid crystal panel is illuminated from behind.

With a conventional liquid crystal module of this type, the main components of a direct type backlight device are the frame to which the linear light sources are attached, the reflective sheet and the light diffuser plate. The reflective sheet and the light diffuser plate are provided on opposite sides of this frame. The reflective sheet is generally provided in a flat shape. The reflective surface formed by the surface of the reflective sheet is a flat surface.

The prior art discloses a reflection type of surface light emitting device designed so that the light from a fluorescent tube is reflected by a reflecting surface formed by the surface of a main unit cover (see, for example, Japanese Laid-Open Patent Application H4-51083). The prior art also discloses a display device designed so that the light from discharge lamps is reflected by parallel reflecting plates having a peaked surface shape at a plurality of sites (see, for example, Japanese Laid-Open Patent Application 2001-59961). The prior art further discloses a liquid crystal display device in which a lamp reflecting plate is disposed on the lower side of a molded frame to which a lamp is attached, and parallel peak shapes are made at a plurality of sites on the reflecting surface of this lamp reflecting plate (see, for example, Japanese Laid-Open Patent Application 2001-59961). The prior art discloses a direct type backlight device in which a divided unit formed by dividing up a reflective surface frame is disposed on the backs of a plurality of light sources disposed in parallel (see, for example, Japanese Laid-Open Patent Application 2005-32575). The prior art discloses a liquid crystal display device in which slits are formed in a diffuser sheet to prevent bleeding into the displayed image (see, for example, Japanese Laid-Open Patent Application 2003-50391).

With the direct type backlight device for a liquid crystal module in the conventional example mentioned above, the light from linear light sources is reflected by a flat reflecting surface, and the light is also diffused by a light diffuser plate so that the liquid crystal panel is illuminated from behind. If the display image of the liquid crystal module (the display screen of the liquid crystal panel) is made large, there is the problem that the display will have uneven brightness. Also, if the size of the frame increases along with the above-mentioned increase in size of the display image, the frame's mechanical properties may be adversely affected because the frame is a resin molding. In particular, the frame's shape stability and the support strength with respect to other components may be inadequate.

The above-mentioned prior art discloses a plurality of peaked shapes that are formed on a reflecting surface. While it is conceivable that this idea could be utilized to expand the region over which light is reflected and suppress brightness unevenness, merely giving the reflecting surface a peaked shape will not improve the shape stability or support strength necessitated by an increase in the size of the above-mentioned resin molding frame.

The present invention is conceived in light of the above situation. It is an object of the present invention to provide a direct type backlight device for a liquid crystal module, with which the optical function of the direct type backlight device is enhanced by modifying the configuration of the frame. In addition, it is an object of the present invention to provide a direct type backlight device, with which the shape stability and support strength of the frame is improved without increasing the number of required components, thereby allowing the mechanical properties of the overall liquid crystal module to be improved. The present invention addresses these needs in the art as well as other needs, which will become apparent to those skilled in the art from this disclosure.

### SUMMARY OF THE INVENTION

The direct type backlight device for a liquid crystal module of the present invention is a direct type backlight device for a liquid crystal module having a liquid crystal panel that includes a resin molded frame, a reflective sheet, a light diffuser plate and at least one crosspiece. The resin molded frame attaches linear light sources disposed in parallel at a plurality of sites spaced apart. The reflective sheet is disposed on one side of the frame. The light diffuser plate is disposed on another side of the frame. The crosspiece is fixed to the frame between adjacent linear light sources and has a light reflecting surface. Light transmitted through the light diffuser plate illuminates the liquid crystal panel. The crosspiece may be integrally molded with the frame.

With this configuration, even if the resin molding frame is made larger and there is a problem where the frame might not have an adequate shape stability or support strength, the crosspiece serves as a structure member that reinforces the frame. Therefore the crosspiece improves the shape stability and supports strength of the frame. As a result, the backlight device helps to improve the mechanical properties of the overall liquid crystal module that has been made larger in size.

Also, because the light reflecting function exhibited by the crosspiece increases brightness between the linear light sources on either side of the crosspiece, the light from the linear light sources incident directly on the light diffuser plate, the light from the linear light sources incident on the light diffuser plate after being reflected by the crosspiece, and the light from the linear light sources incident on the light diffuser plate after being reflected by the reflective sheet all mix together in being transmitted through the light diffuser plate. As a result, even if a liquid crystal panel illuminated from behind by light transmitted through the light diffuser plate is made larger in size, there is dramatically less brightness unevenness on the display screen of the liquid crystal panel. Taking advantage of the fact that there is greater brightness between the linear light sources on either side of the crosspiece, the spacing between linear light sources can be increased so that fewer linear light sources are required. As a result, fewer linear light sources are needed given the size of the display screen of the liquid crystal panel. In particular, with the present invention, the shape of the reflecting surface of the reflective sheet is not changed, but the crosspieces are added to the frame. Therefore, it is possible to solve the problem of shape loss of the reflecting surface and so forth, which tended to occur when the shape of the reflecting surface was changed.

With the present invention, it is preferable if the crosspiece has a peaked cross sectional shape with a peak, and a surface of the peak of the crosspiece is the light reflecting surface. The light from the linear light sources that hits the crosspiece is reflected toward both the light diffuser plate and the spaces between adjacent linear light sources. As a result, a good balance is maintained between the amount of light incident on the light diffuser plate and the increase in brightness between the linear light sources. Accordingly, brightness unevenness on the display screen of the liquid crystal panel is even more dramatically suppressed.

With the present invention, it is preferable if the frame is rectangular, and the linear light sources and the crosspiece extend in a longitudinal direction of the rectangular frame. The result of this is that the role of the crosspiece as a structural member dramatically improves the warping resistance of an oblong frame of a direct type backlight device corresponding to the oblong screens that are found on many television receivers that make use of a liquid crystal module.

With the present invention, it is preferable if a plurality of protrusions that protrude toward the light diffuser plate are spaced apart in a row along the crosspiece, and a top of each of the protrusions is proximal to and across from the light diffuser plate. Even though the height of the crosspiece is reduced and its shadow can therefore be prevented from falling on the light diffuser plate, when the light diffuser plate is bent so as to bulge toward the inside of the frame, the bending deflection amount is restricted to a microscopic extent by the tops of the protrusions. Therefore, it is possible to suppress the decrease in image quality that would otherwise be caused by the bending deflection of the light diffuser plate.

With the present invention, it is preferable if, when the light diffuser plate is bent from its original position so as to bulge toward the inside of the frame, the tops of the protrusions hit a bulging region of the light diffuser plate so that a bending deflection amount of the light diffuser plate is restricted. There is no decrease in image quality due to the liquid crystal panel for the reasons given above. In addition, the bending deflection amount will be kept to a certain amount or less and the light diffusion effect will tend to remain uniform even if the light diffuser plate should bend under the effect of temperature or the like. As a result, the brightness unevenness on the display screen of the liquid crystal panel attributable to bending of the light diffuser plate will be prevented from occurring.

With the present invention, it is preferable if the reflective sheet is linked to the crosspiece where the reflective sheet overlaps the crosspiece. The result of this is that even if the reflective sheet is formed from a thin, flexible sheeting material, there will be no reflection unevenness attributable to the bending of the reflective sheet. That is because the reflective sheet is supported not only around areas of overlap with the frame, but also is supported by the crosspiece in the middle portions thereof. Furthermore, there will be no need to use a separate part (such as a panel post) to prevent the reflective sheet from bending. This helps to improve mass production.

As discussed above, with the direct type backlight device for a liquid crystal module pertaining to the present invention, there is no change in the shape of the reflecting surface used to reflect light from the linear light sources. But the configuration of the frame that supports the reflective sheet is changed, which enhances the optical function of the direct type backlight device, and suppresses brightness unevenness on the display screen of the liquid crystal panel of the liquid crystal module. Accordingly, the optical performance of the direct type backlight device is higher and the user can enjoy images of higher quality. In addition to that, the mechanical properties of the overall liquid crystal module are also improved, such as better durability through an increase in support strength and shape stability of the frame. Also, at least one crosspiece can be added by integral molding to the frame, an advantage of which is that there is no increase in cost due to an increase in the number of parts involved.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a simplified, exploded oblique view of the main components of the direct type backlight device for a liquid crystal module pertaining to an preferred embodiment of the present invention;

FIG. 2 is a plan view of a frame 2;

FIG. 3 is an enlarged cross section along the III-III line in FIG. 2;

FIG. 4 is a cross section of a modification example corresponding to FIG. 3;

FIG. 5 is a simplified oblique view of the measures taken to prevent bending of a light diffuser plate 4; and

FIG. 6 is a partial cross section of the measures taken to prevent bending of a reflective sheet 3.

### DETAILED DESCRIPTION OF THE PREFERRED EMBODIMENTS

A preferred embodiment of the present invention will now be explained with reference to the drawings. It will be apparent to those skilled in the art from this disclosure that the following description of the preferred embodiment of the present invention is provided for illustration only and not for the purpose of limiting the invention as defined by the appended claims and their equivalents.

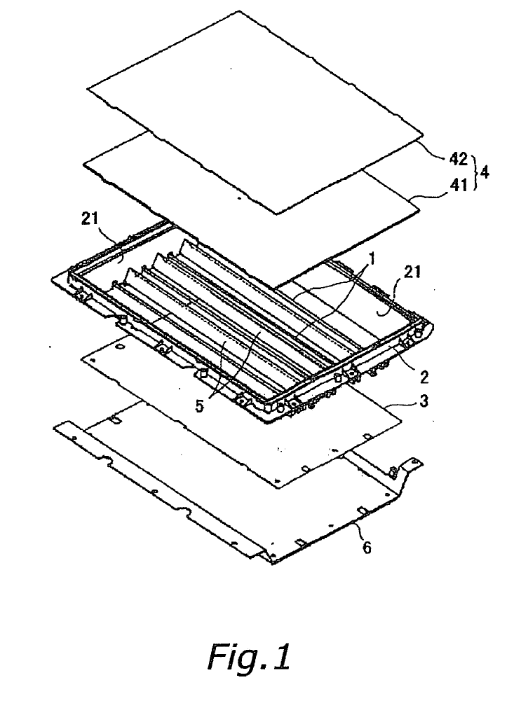

As shown in FIG. 1, a direct type backlight device includes linear light sources 1, a rectangular frame 2 to which the linear light sources 1 are attached, a reflective sheet 3, a light diffuser plate 4 and a back plate 6 made of sheet metal. The reflective sheet 3 and the diffuser plate 4 are provided on opposite sides of the frame 2. The light diffuser plate 4 is constituted by a main plate 41 of high rigidity and a sheet 42. The main plate 41 and the sheet 42 are superposed one over the other.

With this direct type backlight device, the linear light sources 1 are formed by straight or U-shaped fluorescent tubes, and are attached in parallel, equidistantly spaced apart, at a plurality of sites (four sites in the depicted example) in a lateral (vertical) direction of the frame 2, which is in the form of a hollow rectangle.

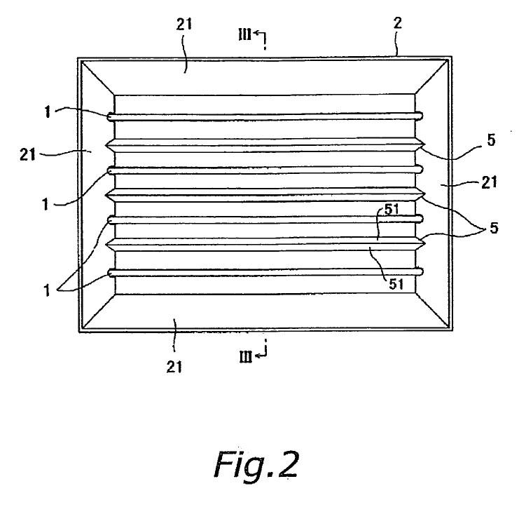

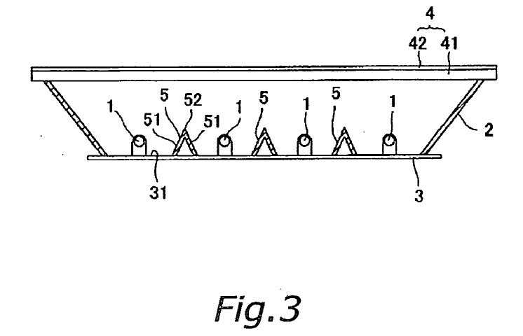

The frame 2 is a resin molding, and its inner faces 21 on the top, bottom, left, and right are sloped so as to widen forward. As shown in FIGS. 2 and 3, the frame 2 is provided with a plurality of crosspieces 5, each of which is disposed in between two adjacent linear light sources 1. These crosspieces 5 extend in a longitudinal (horizontal) direction between the left and right inner faces 21 of the frame 2, and extend parallel to the linear light sources 1. As shown in FIG. 3, the crosspieces 5 are formed with a peaked cross sectional shape. A surface of the peaks of the crosspieces 5 is formed as a light reflecting surface 51 that is colored white, for example, with a wide gap maintained between the light diffuser plate 4 and the tops (ridgelines) 52 of the crosspieces 5.

As shown in FIG. 3, the reflective sheet 3 is disposed in a flat shape, and the reflecting surface 31 formed by the surface of the reflective sheet 3 is also flat.

With the direct type backlight device constituted as above, the light from the linear light sources I is incident directly on the light diffuser plate 4, is incident on the light diffuser plate 4 after first being reflected by the flat reflecting surface 31 of the reflective sheet 3, and is incident on the light diffuser plate 4 after being reflected by the light reflecting surface 51 of the crosspieces 5. As a result, the light transmitted through the light diffuser plate 4 illuminates or backlights the liquid crystal panel (not shown) from behind.

In this case, since the light reflecting surface 51 of the crosspieces 5 also reflects the light from the linear light sources 1 laterally, brightness increases between the linear light sources 1 on either side of the crosspieces 5. Research has revealed that with the direct type backlight device of this configuration, even if the liquid crystal panel illuminated from behind with light that has been transmitted through the light diffuser plate 4 is increased in size up to about 20 inches, there will be no brightness unevenness at all on the display screen of the liquid crystal panel. Even if there is some brightness unevenness, it will be suppressed to the extent that it will not be discernible by the eye. This tells us that depending on the size of the liquid crystal panel, spacing between the linear light sources 1 can be increased and the number of linear light sources 1 required can be reduced, which is beneficial in that fewer linear light sources 1 are needed given the size of the display screen of the liquid crystal panel.

In this embodiment, the reflective sheet 3 itself is formed by a flexible, thin sheeting material that is disposed flat, and the reflective sheet 3 itself does have the property of being relatively easily deformed under the effect of temperature. However, because it is used while held flat, it could also be said to be relatively resistant to deformation under the effect of temperature. In regard to this point, instead of adding the crosspieces 5 to the frame 2, for example, the reflective sheet 3 could be folded or otherwise worked so as to have peaked reflecting surfaces at a plurality of places, but doing this makes the reflective sheet 3 more susceptible to bending under the effect of temperature. Therefore, an advantage to adding the crosspieces 5 to the frame 2 and using the surfaces thereof as the light reflecting surfaces 51 as in this embodiment is that decreases in optical performance caused by the effect of temperature can be suppressed.

Also, if the light reflecting surfaces 51 of the crosspieces 5 are formed in a peaked shape, then the light from the linear light sources 1 that hits the crosspieces 5 will be reflected toward both the light diffuser plate 4 and the spaces between adjacent linear light sources 1. As a result, a good balance is maintained between the amount of light incident on the light diffuser plate 4 and the increase in brightness between the linear light sources 1. Accordingly, brightness unevenness on the display screen of the liquid crystal panel is even more dramatically suppressed.

Meanwhile, since the crosspieces 5 are formed integrally with the frame 2, these crosspieces 5 also exhibit a function as structural members that reinforce the frame 2. Accordingly, even if the frame 2 is made larger for the purpose of accommodating a liquid crystal panel about 20 inches in size, for example, the shape stability and support strength of the frame 2 will be improved enough for the frame to have adequate strength and so on. Therefore, forming the crosspieces 5 integrally with the frame 2 helps to improve the overall mechanical properties of a larger liquid crystal module. In particular, in this embodiment, the warping resistance and so forth of the oblong frame 2 are dramatically improved by the role of the crosspieces 5 as structural members, and this improves the mechanical properties of the direct type backlight device corresponding to the oblong screens that are found on many television receivers.

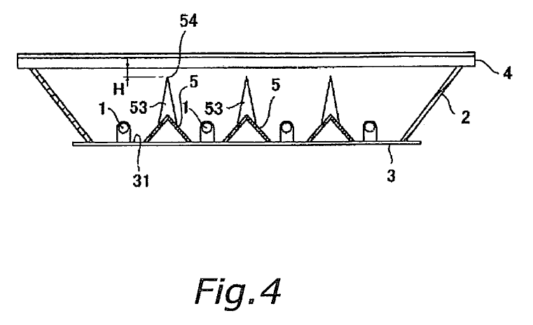

FIG. 4 depicts an example in which a plurality of pointed protrusions 53 that protrude toward the light diffuser plate 4 are arranged spaced apart in a row along each of the crosspieces 5. The protrusions 53 have tops 54 that are positioned close to and across from the light diffuser plate 4. When the light diffuser plate 4 is bent from its original position so as to bulge toward the inside of the frame 2, the tops 54 of some of the protrusions 53 hit the bulging region of the light diffuser plate 4 so that the bending deflection amount of the light diffuser plate 4 is restricted.

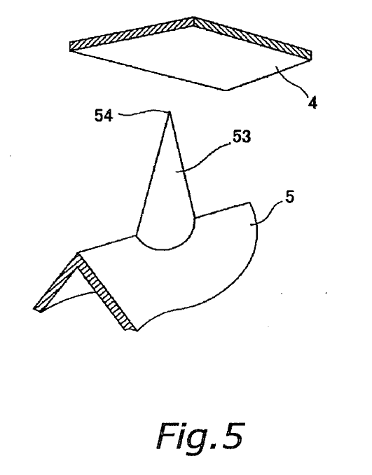

In this configuration, if the spacing H between the light diffuser plate 4 and the tops 54 of the protrusions 53 is set ahead of time to a specific value, then, when the light diffuser plate 4 is bent under the effect of temperature or the like from its original position so as to bulge toward the inside of the frame 2, the tops 54 of the crosspieces 5 will hit the bulging region of the light diffuser plate 4 so that the bending deflection amount of the light diffuser plate 4 is restricted. This prevents the bending deflection amount of the light diffuser plate 4 from increasing more than permissible and becoming a source of unevenness in brightness. In addition, by suitably setting the height of the protrusions 53, the height of the crosspieces 5 is kept low enough that a shadow of the crosspieces 5 will not fall on the light diffuser plate 4. Thus, no situation will arise in which the shadow of the crosspieces 5 falls on the light diffuser plate 4 to lower the image quality of the liquid crystal panel. FIG. 5 depicts an example in which the pointed protrusions 53 are in a conical shape. However, the shape of the protrusions 53 may be some other pointed shape besides the conical shape shown in FIG. 5. For example, a pyramid shape may be selected.

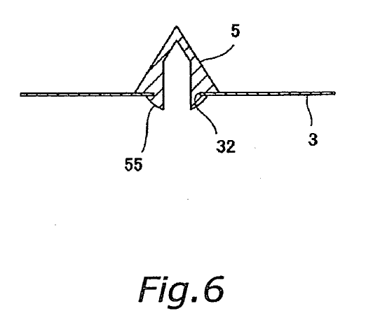

In this embodiment, the bottom end faces of the crosspieces 5 are made to line up with the end faces on the back side of the frame 2. Accordingly, the reflective sheet 3 disposed on one side of the frame 2 is not only located at the end faces on the back side of the frame 2, but also overlaps the bottom end faces of the crosspieces 5. Referring to FIG. 6, a plurality of engagement holes 32 is formed in the reflective sheet 3 at overlapping points with the crosspieces 5. A plurality of engagement prongs 55 are integrally provided to the bottom end faces of the crosspieces 5. The engagement prongs 55 are pushed into and linked in the engagement holes 32 to keep the reflective sheet 3 supported by the crosspieces 5. Thus, even though the reflective sheet 3 is formed of a flexible, thin sheet material, the reflective sheet 3 is supported not only around areas of overlap with the frame 2, but also by the crosspieces 5 in a middle portions thereof. As a result, there will be no reflection unevenness attributable to bending of the reflective sheet 3. In this case, since the places where the crosspieces 5 and the reflective sheet 3 overlap are places that do not contribute to the reflection of light, even if the crosspieces 5 and the reflective sheet 3 are linked as above at these overlapping sites, there will be no loss of light reflecting performance by the reflective sheet 3.

### GENERAL INTERPRETATION OF TERMS

In understanding the scope of the present invention, the term “configured” as used herein to describe a component, section or part of a device includes hardware and/or software that is constructed and/or programmed to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only a preferred embodiment has been chosen to illustrate the present invention, it will be apparent to those skilled in the art from this disclosure that various changes and modifications can be made herein without departing from the scope of the invention as defined in the appended claims. Furthermore, the foregoing description of the preferred embodiment according to the present invention is provided for illustration only, and not for the purpose of limiting the invention as defined by the appended claims and their equivalents.

What is claimed is:

1. A direct type backlight device for a liquid crystal module having a liquid crystal panel, comprising:
a resin molded frame configured to attach a plurality of linear light sources in parallel at a plurality of sites spaced apart;
a reflective sheet disposed on one side of the frame;
a light diffuser plate disposed on another side of the frame, the light diffuser plate being configured to illuminate the liquid crystal panel when light is transmitted there through; and
at least one crosspiece fixed to the frame between adjacent linear light sources, and having a light reflecting surface.

2. The direct type backlight device for a liquid crystal module according to claim 1, wherein
the crosspiece is integrally molded with the frame.

3. The direct type backlight device for a liquid crystal module according to claim 1, wherein
the crosspiece has a peaked cross sectional shape with a peak, and a surface of the peak of the crosspiece is the light reflecting surface.

4. The direct type backlight device for a liquid crystal module according to claim 1, wherein
the frame is rectangular, and the linear light sources and the crosspiece extend in a longitudinal direction of the rectangular frame.

5. The direct type backlight device for a liquid crystal module according to claim 4, wherein
a plurality of protrusions that protrude toward the light diffuser plate are spaced apart in a row along the crosspiece, and a top of each of the protrusions is proximal to and across from the light diffuser plate.

6. The direct type backlight device for a liquid crystal module according to claim 5, wherein
when the light diffuser plate is bent from its original position so as to bulge toward the inside of the frame, the tops of the protrusions hit a bulging region of the light diffuser plate so that a bending deflection amount of the light diffuser plate is restricted.

7. The direct type backlight device for a liquid crystal module according to claim 1, wherein
the reflective sheet is linked to the crosspiece where the reflective sheet overlaps the crosspiece.

8. The direct type backlight device for a liquid crystal module according to claim 1, wherein
a plurality of the crosspieces are fixed to the frame in the middle of the adjacent linear light sources,
the plurality of the crosspieces each have a peaked cross sectional shape with a peak, and a surface of the peak is the light reflecting surface,
the frame is rectangular,
the linear light sources and the crosspieces extend in a longitudinal direction of the frame,
a plurality of protrusions that protrude toward the light diffuser plate are spaced apart in a row along the crosspieces,
a top of each of the protrusions is proximal to and across from the light diffuser plate, and
when the light diffuser plate is bent from its original position so as to bulge toward the inside of the frame, the tops of the protrusions hit a bulging region of the light diffuser plate so that a bending deflection amount of the light diffuser plate is restricted.

9. The direct type backlight device for a liquid crystal module according to claim 1, wherein
a plurality of the crosspieces are fixed to the frame in the middle of the adjacent linear light sources,
the plurality of the crosspieces each have a peaked cross sectional shape with a peak, and a surface of the peak is the light reflecting surface,
the frame is rectangular,
the linear light sources and the crosspieces extend in a longitudinal direction of the frame,
a top of each of the crosspieces is spaced apart from the light diffuser plate, and
the reflective sheet is linked to the crosspieces where the reflective sheet overlaps the crosspieces.
